(19) United States
(12) Patent Application Publication
(10) Pub. No.: US 2022/0090390 A1
(43) Pub. Date: Mar. 24, 2022

(54) FLOOR OR WALL PANEL

(71) Applicant: FLOORING INDUSTRIES LIMITED, SARL, Bertrange (LU)

(72) Inventors: Pieter-Jan SABBE, Merelbeke (BE); Laurent MEERSSEMAN, Mont de l'Enclus (BE); Jochen BOSSUYT, Tiegem (BE)

(21) Appl. No.: 17/421,663

(22) PCT Filed: Jan. 7, 2020
(86) PCT No.: PCT/IB2020/050086

§ 371 Date: Jul. 8, 2021

(30) Foreign Application Priority Data
Jan. 10, 2019 (BE) 2019/5011

(51) Int. Cl. E04F 15/02; B32B 5/18; B32B 27/06; B32B 7/12; B32B 27/20; B32B 27/30; E04F 13/08; E04F 13/18; E04F 15/10

(52) U.S. Cl. CPC E04F 15/02144; E04F 2201/043; B32B 27/065; B32B 7/12; B32B 27/20; B32B 27/304; E04F 15/02038; E04F 13/0883; E04F 13/18; E04F 15/105; E04F 15/107; E04F 13/0866; B32B 2471/00; B32B 2307/208; B32B 2264/10; B32B 2266/0278; B32B 2607/00; B32B 5/18

(57) ABSTRACT

A method for producing a floor or wall panel, includes the provision of a first thermoplastic polymer layer that comprises a polymer matrix and ferromagnetic and/or ferrimagnetic particles; the provision of a second thermoplastic polymer layer, with the second layer in contact with the first layer along a side of the first layer; the bonding to one another of the first, the second and the optionally further polymer layers under elevated temperature and pressure; the provision of a decorative layer on the side of the second layer opposite to the side in contact with the first layer; the provision of a translucent or transparent wear layer in contact with the decorative layer.

### TECHNICAL FIELD

The present invention relates to floor or wall panels and methods for the production thereof.

### PRIOR ART

Floor or wall panels are widely known. A drawback of many of these panels is the requirement that they must be undetachably bonded to the underlying floor or wall structure, for example a wall or a concrete floor element.

This bonding is often carried out by gluing. Subsequent detachment of the panels is laborious, or in some cases completely impossible, without damaging the panel.

A detachable bond based on magnetism is known, for example from EP 1768527 B1. Magnetic floor panels are laid on a floor provided with a paint containing ferromagnetic particles.

### SUMMARY OF THE INVENTION

An object of the invention is to provide floor or wall panels that can easily be magnetized or are magnetic.

According to a first aspect, a method for producing a floor or wall panel is provided, which method comprises:
the provision of a first thermoplastic polymer layer that comprises a polymer matrix and ferromagnetic and/or ferrimagnetic particles;
the provision of a second thermoplastic polymer layer, wherein the second layer is in contact with the first layer along a side of the first layer;
the optional provision of one or more further thermoplastic polymer layers on the side of the second layer opposite to the side in contact with the first layer;
the bonding to one another of the first, the second and the optionally further polymer layers under elevated temperature and pressure;
the provision of a decorative layer on the side of the second layer opposite to the side in contact with the first layer or if applicable on the side of one of the further polymer layers, which side is oriented away from the first polymer layer;
the optional provision of a translucent or transparent wear layer in contact with the decorative layer.

The elevated temperature is a temperature that is at or above the processing or melting temperature of the thermoplastic polymer layer.

Particles are to be understood as particulates.

The ferromagnetic and/or ferrimagnetic particles can consist for example of iron or iron alloys, nickel, cobalt, aluminium and/or copper, optionally with other alloy elements, or can be ceramic substances comprising barium ferrite (BaFe₁₂O₁₉), strontium ferrite (SrFe₁₂O₁₉) or barium strontium ferrite (BaₓSr₁₋ₓFe₁₂O₁₉). According to embodiments, the particles can be ferrite particles. According to embodiments, the particles can be strontium ferrite particles.

According to embodiments, the ferromagnetic and/or ferrimagnetic particles can be permanent magnetic particles.

The ferromagnetic and/or ferrimagnetic particles preferably have an average size (diameter) of 0.5 to 5 μm.

Preferably, this average size is in the range of 1 to 4 μm, such as in the range of 1 to 3 μm, such as between 1.5 to 2.3 μm.

According to some embodiments, the first and/or second polymer layer can be provided by extrusion, possibly co-extrusion.

According to some embodiments, a dual belt press can be provided that successively comprises a heating zone, a pressing zone and a cooling zone, wherein a lower and upper cooperating conveyor belt form a product gap that extends through this heating, pressing and cooling zone, and wherein the provision of the first polymer layer comprises the provision of a first particle layer comprising ferromagnetic and/or ferrimagnetic particles and polymer particles, wherein this particle layer is converted into a polymer layer comprising a polymer matrix and the above-mentioned ferromagnetic and/or ferrimagnetic particles under the action of temperature and pressure in the product gap.

According to some embodiments, the first particle layer comprising ferromagnetic and/or ferrimagnetic particles and polymer particles can be scattered on the lower of the two conveyor belts.

According to embodiments, ferromagnetic and/or ferrimagnetic particles are first scattered on the lower of the two conveyor belts, after which a layer of polymer particles is scattered on this particle layer in order to obtain the first particle layer. If applicable, different layers of ferromagnetic and/or ferrimagnetic particles and polymer particles can be alternately scattered on one another.

According to other embodiments, the ferromagnetic and/or ferrimagnetic particles and the polymer particles are first mixed with one another in a mixing unit, after which a mixture of ferromagnetic and/or ferrimagnetic particles and polymer particles is scattered on the lower of the two conveyor belts in order to obtain the first particle layer.

Typical particle sizes for the polymer particles in these embodiments are an average particle size of between 200 μm and 500 μm, for example an average of 300 μm, wherein the maximum size of the particles is not greater than for example 1 mm. The layer thickness laid down is a minimum of 400 μm, but is preferably between 1 and 3.5 mm.

According to still other embodiments, the provision of a first thermoplastic polymer layer that comprises a polymer matrix and ferromagnetic and/or ferrimagnetic particles consists of the scattering of granules or flakes, which granules themselves consist of a mixture of a polymer material and ferromagnetic and/or ferrimagnetic particles. This polymer material and the ferromagnetic and/or ferrimagnetic particles are first mixed, extruded, and cut or ground into granules. Typical dimensions of such granules, which however are not to be understood as limitative, are cylindrical granules with a diameter of between 1 and 3.5 mm and a length of between 0.5 and 1 mm. The layer thickness laid down is a minimum of 1.4 to 1.5 mm, but is preferably between 1.4 and 3.5 mm.

According to some embodiments, the second layer of polymer particles can be scattered on the particle layer comprising ferromagnetic and/or ferrimagnetic particles and polymer particles and wherein this second layer of polymer particles is converted in the dual belt press into the second thermoplastic polymer layer. The second layer of polymer particles is preferably free of ferromagnetic and/or ferrimagnetic particles.

Possibly, further layers of thermoplastic polymer particles can also be scattered on the second layer of polymer particles. If applicable, one or more reinforcing materials, such as fibre nonwovens or woven textile materials, for example glass fibre nonwovens or glass fibre wovens, are placed between the particle layers or embedded in a layer of thermoplastic polymer particles.

The thermoplastic polymer particles used may comprise plasticizers and/or dyes and/or fillers and/or other common additives.

The thermoplastic layers formed can consist of hard, soft, or semi-soft (or semi-hard) thermoplastic polymers by using different amounts of plasticizers. The thermoplastic layers formed can be foamed or unfoamed, whether or not by means of mechanical foaming or chemical foaming (by using foaming agents in the polymer particles), or can be foamed by using foam-forming fillers.

The two conveyor belts can be polymer conveyor belts, for example glass-fibre-reinforced polymer belts provided with a Teflon coating on the sides facing each other.

The pressing device can comprise an S-bend and/or steel belt press, for example an isochoric or isobaric steel belt press in order to exert pressure.

The cooling and/or heating zone can comprise different cooling or heating plates, wherein the temperature in the feed direction of the conveyor belts can be constant or varied.

Methods which are based on scattering ferromagnetic and/or ferrimagnetic particles and the use of a dual belt press have the advantage that the ferromagnetic and/or ferrimagnetic particles can be positioned very accurately in the depth of the polymer layer. Thus, it is for example possible to prevent the use in the depth of the polymer of an excess of particles which do not contribute sufficiently to bonding, and/or the concentration of the amount of ferromagnetic and/or ferrimagnetic particles can be kept within narrow limits. This leads to a more efficient use of material.

According to some embodiments, the polymer materials of the first and second polymer layer can comprise polyvinyl chloride (PVC).

According to embodiments, the PVC of the first and/or the second and/or further layer of PVC can be hard, semi-hard or soft PVC. Preferably, the polymer material comprises plasticizers in an amount of 15 to 100 phr, and preferably in an amount of 20 to 100 phr, e.g. 30 to 100 phr, for example 50 to 80 phr. “Phr” means parts by weight of plasticizer per hundred parts by weight of polymer. The plasticizers can include esters of carboxylic acids (for example esters of ortho- or terephthalic acid, trimellitic acid, benzoic acid and adipic acid), for example diisononyl phthalate (DINP), dioctyl terephthalate (DOTP), di-isononyl-1,2-cyclohexane dicarboxylate (DINCH), esters of phosphoric acid, for example triaryl- or trialkylaryl phosphates, for example tricresyl phosphate, chlorinated or unchlorinated hydrocarbons, ethers, polyesters, polyglycols, sulphonamides, or combinations thereof.

According to the invention, soft PVC refers to PVC comprising more than 20 phr of a plasticizer, and semi-hard PVC comprises between 15 and 20 phr of a plasticizer. Hard PVC is understood to be PVC with less than 5 phr of a plasticizer.

In an alternative form, the PVC of the first layer and/or the second layer is hard or semi-hard PVC, i.e. PVC containing no plasticizer or between 0 and 15 phr of a plasticizer.

The PVC used preferably has a K value (Fikentscher) of less than or equal to 85, for example less than or equal to 60, for example less than 58, such as for example a K value of 57 or 50. PVC can also be a copolymer of vinyl chloride (VC) and vinyl acetate (VA), for example copolymers with a VC/VA ratio of 70/30 to 50/50.

According to some embodiments, the second thermoplastic material can be unfoamed thermoplastic material. According to some embodiments, the second thermoplastic material can be foamed thermoplastic material. The average density of the PVC in unfoamed form is preferably between 1 and 2 g/cm³, such as between 1.6 and 2 g/cm³. The foamed form can show foaming of 10 to 100%, i.e. the density “A” of the unfoamed form is reduced by a factor of 1.1 to 2. In other words, if the density of the unfoamed PVC is “A”, then the density of the foamed PVC is between A/1.1 and A/2.

A foamed layer refers to a layer containing hollow spaces, preferably in an amount such that the density of the material is reduced by at least 10%, and preferably even at least 25%, relative to the weight of the same volume of thermoplastic material without hollow spaces. Preferably, it is so-called “closed cell” foam, although the foam can also be open foam. An unfoamed layer refers to a layer without hollow spaces, or at least with a maximum proportion of hollow spaces such that the density of the material is not reduced, or is not reduced by more than 10%, and preferably not more than 2%.

In general, it is also noted that in the context of the invention, a foamed layer need not necessarily be foamed in a uniform manner. It is possible for the foamed layer to comprise a varying number of hollow spaces throughout its thickness. For example, the highest proportion can be reached in the centre of the layer, while on one or more of the surfaces of such a layer, less foamed or even unfoamed zones may be present.

The foamed layer can be obtained in different possible ways, with the three primary possibilities being listed below.

According to a first possibility, the foamed layer is obtained at least by means of a mechanical foaming process. This means that holes are formed in the relevant layer by displacing the thermoplastic material and replacing it with a gas (for example air), often under the influence of a mechanical action or by blowing in a gas (for example air) under pressure.

According to a second possibility, the foamed layer is obtained at least by means of a chemical foaming process. This means that holes are formed in the relevant layer by means of a gaseous reaction product. For example, azodicarbonamide can be used. When heated, this substance releases nitrogen gas that remains in the foamed layer in the form of bubbles.

According to a third possibility, the foamed layer is obtained at least by means of fillers, wherein these fillers themselves comprise one or more holes. For example, one can make use of the expanded state of microspheres in this case, or the layer can be obtained by using expanding granules in a PVC-based layer. More specifically, one can use the microspheres known from WO 2013/178561.

The thermoplastic polymer material of the first and/or the second or further layer can also comprise fillers in addition to a polymer matrix.

Fillers can include glass fibres, calcium hydroxide (slaked lime), calcium carbonate and calcium hydrogen carbonate, talc, or also light-weight fillers such as hollow microspheres (Expancel). These fillers can be present in an amount of 50 to 300 phr. “Phr” refers to parts by weight of filler per hundred parts by weight of polymer.

Furthermore, the thermoplastic polymer material can also comprise additives such as flame retardants, antioxidants, antifungals, UV stabilizers, and organic or inorganic dyes or organic or inorganic pigments, for example carbon black pigment and the like.

According to some embodiments, after the formation of the at least first and second, and if applicable further thermoplastic polymer layers, a decorative layer can be laminated onto the side of the second layer opposite to the side in contact with the first layer, or if applicable onto the side of one of the further polymer layers, which side is oriented away from the first polymer layer.

According to some embodiments, the decorative layer comprises a printed motif. According to some embodiments, the decorative layer comprises a thermoplastic film, preferably PVC film. According to some embodiments, the film is provided with a decorative print. According to some embodiments, the printed motif is an inkjet printed motif. According to some embodiments, the printed motif is an inkjet printed motif that is printed on the upper side of the upper second or one of the multiple layers of thermoplastic material. The decorative layer preferably has a thickness of between 0.07 and 0.1 mm.

According to some embodiments, a transparent or translucent wear layer can be laminated onto the decorative layer. According to some embodiments, the wear layer can be a transparent or translucent PVC layer that optionally comprises wear-resistant particles.

Preferably, such a wear layer consists primarily of thermoplastic material, preferably PVC, for example with a thickness of between 0.15 and 0.75 mm.

According to some embodiments, the wear layer comprises a lacquer layer bordering on the surface. Therefore, according to some embodiments, the upper side can be provided with a lacquer layer

Examples of usable lacquer layers are lacquer layers based on urethane acrylates, polyester acrylates and/or epoxide acrylates.

The lacquer layer can be a lacquer layer that is cured by means of UV radiation or excimer radiation.

The lacquer layer can also comprise wear-resistant particles.

The relevant lacquer layer can comprise hard particles, for example of aluminium oxide, for example corundum, and/or silica in order to obtain increased wear resistance.

According to some embodiments, the laminating of the transparent or translucent wear layer and the decorative layer can take place in one and the same laminating step.

If applicable, a relief is further applied by means of indentation, or a so-called embossing step, and a transparent resin layer is optionally also applied to the wear layer, for example a UV curing polyurethane layer.

The embossing can optionally be in register with the image on the decorative layer.

According to some embodiments, the method can also comprise a step wherein the above-mentioned ferromagnetic and/or ferrimagnetic particles are magnetized.

This can take place by means of permanent or electromagnets that produce a magnetic field by means of which the particles are magnetically oriented.

According to some embodiments, at least one reinforcing layer can be applied between the first thermoplastic polymer layer and the second thermoplastic polymer layer, or in the first thermoplastic polymer layer and/or the second thermoplastic polymer layer. In cases where one or more further thermoplastic polymer layers are provided, at least one reinforcing layer is preferably applied between the second thermoplastic polymer layer and the one or more thermoplastic polymer layers, or between two of the one or more thermoplastic polymer layers.

These one or more thermoplastic polymer layers are preferably free of ferromagnetic and/or ferrimagnetic particles.

The reinforcing layers are for example textile reinforcing layers, preferably of glass fibres. For example, the reinforcing layers can be glass fibre wovens or glass fibre nonwovens.

This textile reinforcing layer is preferably a glass-fibre-comprising textile reinforcing layer such as a glass fibre nonwoven or a glass fibre woven. Preferably, a glass fibre nonwoven is used that preferably can have a surface weight of between 30 and 60 g/m² and a thickness of between 0.20 and 0.45 mm, for example between 0.25 and 0.45 mm.

The surfaces thus obtained can be cut or sawn into panels, which typically but in a non-limitative manner have a square, parallelogram-shaped, trapezoidal, diamond-shaped or rectangular perimeter. If applicable, they can be provided with coupling means on one or both pairs of sides, which coupling means can cooperate with the coupling means of identical panels.

According to some embodiments, the method can further comprise the cutting of the layered structure obtained into panels.

According to some embodiments, the panels can be provided on one or more sides with a coupling system. This can be done by milling, sawing, and similar processing methods known in the prior art.

According to some embodiments, the panels can have a square, parallelogram-shaped, trapezoidal, diamond-shaped or rectangular perimeter, and wherein the sides are free of coupling means.

According to a second aspect, a floor or wall panel is provided that is obtained according to a method according to the first aspect.

According to a third aspect, a floor or wall panel is provided wherein the panel comprises an upper side and an underside, the panel comprising a core of thermoplastic polymer material that provides the floor panel with its underside, wherein the thermoplastic polymer material comprises a polymer matrix and ferromagnetic and/or ferrimagnetic particles. The ferromagnetic and/or ferrimagnetic particles are therefore present on the underside of the panel, but they are contained in the polymer matrix that provides the core of the panel.

The core of thermoplastic polymer material can consist of different layers. According to embodiments, the panel can comprise an upper side and an underside, the panel comprising a first layer of a first thermoplastic polymer material and at least a second layer of a second thermoplastic polymer material, wherein this first layer provides the floor panel with its underside, the second layer is in contact with the first layer along the side of the first layer different from the underside, wherein the first layer of a first thermoplastic polymer material comprises a polymer matrix and ferromagnetic and/or ferrimagnetic particles.

According to embodiments, the second layer comprises a thermoplastic polymer material which is preferably identical to the polymer matrix of the first layer. The thermoplastic polymer material of the second layer and the polymer matrix of the first layer are fused to one another.

This second thermoplastic polymer layer is preferably free of ferromagnetic and/or ferrimagnetic particles.

Preferably, the floor or wall panel also comprises one or more further thermoplastic polymer layers, and preferably at least one reinforcing layer, applied between the second thermoplastic polymer layer and the one or more thermoplastic polymer layers, or between two of the one or more thermoplastic polymer layers.

These one or more thermoplastic polymer layers are preferably free of ferromagnetic and/or ferrimagnetic particles.

The panels according to the third aspect can be panels according to the second aspect of the invention. The panels according to the second and third aspect can have the features described in relation to the methods according to the first aspect of the invention.

The floor or wall panels according to the invention are characterized in that the first layer of a first thermoplastic polymer material, which also comprises ferromagnetic and/or ferrimagnetic particles, and the second layer of a second thermoplastic polymer material are bonded to each other without using adhesive, i.e. are connected by adhesive-free bonding. The floor or wall panels according to the invention are advantageous in that the magnetic or ferromagnetic and/or ferrimagnetic particles are embedded in the polymer matrix and consequently remain in the product with greater reliability in the case of repeated use and re-laying.

According to embodiments, the first thermoplastic polymer material can be polyvinyl chloride. According to embodiments, the second thermoplastic polymer material can be polyvinyl chloride.

According to embodiments, the panel further comprises thermoplastic polymer layers, for example PVC layers.

According to embodiments, the PVC of the first and/or the second and/or further layer of PVC can be semi-hard or soft PVC. Preferably, the polymer material comprises plasticizers in an amount of 15 to 100 phr, and preferably in an amount of 20 to 100 phr, e.g. 30 to 100 phr, for example 50 to 80 phr. “Phr” means parts by weight of plasticizer per hundred parts by weight of polymer. The plasticizers can include esters of carboxylic acids (for example esters of ortho- or terephthalic acid, trimellitic acid, benzoic acid and adipic acid), for example diisononyl phthalate (DINP), dioctyl terephthalate (DOTP), di-isononyl-1,2-cyclohexane dicarboxylate (DINCH), esters of phosphoric acid, for example triaryl- or trialkylaryl phosphates, for example tricresyl phosphate, chlorinated or unchlorinated hydrocarbons, ethers, polyesters, polyglycols, sulphonamides, or combinations thereof.

According to the invention, soft PVC refers to PVC comprising more than 20 phr of a plasticizer, and semi-hard PVC comprises between the 15 and 20 phr of a plasticizer.

In an alternative form, the PVC of the first layer is hard or semi-hard PVC, i.e. PVC that comprises no plasticizer or between 0 and 15 phr of a plasticizer.

The ferromagnetic and/or ferrimagnetic particles can consist for example of iron or iron alloys, nickel, cobalt, aluminium and/or copper, optionally with other alloy elements, or can be ceramic substances comprising barium ferrite (BaFe₁₂O₁₉), strontium ferrite (SrFe₁₂O₁₉) or barium strontium ferrite (BaₓSr₁₋ₓFe₁₂O₁₉). According to embodiments, the particles can be ferrite particles. According to embodiments, the particles can be strontium ferrite particles. According to embodiments, the particles can be permanent magnetic particles.

According to embodiments, the combination of the first and second layer can have a thickness of 0.5 to 3 mm. Preferably, the combination of the first and second layer has a thickness of 0.5 to 2 mm, for example between 0.5 and 1.5 mm.

Preferably, the floor or wall panel also comprises one or more further thermoplastic polymer layers.

These one or more further thermoplastic polymer layers can preferably have a combined thickness of 0.15 to 3 mm, more specifically a thickness preferably of 0.15 to 1.6 mm.

According to embodiments, at least one reinforcing layer can be present between the first layer and the at least second layer of a second thermoplastic material, in the second layer, or if applicable in or between the one or more further thermoplastic polymer layers. These reinforcing layers are for example textile reinforcing layers, preferably of glass fibres. The reinforcing layers can thus for example be glass fibre wovens or glass fibre nonwovens.

This textile reinforcing layer is preferably a glass-fibre-comprising textile reinforcing layer such as a glass fibre nonwoven or a glass fibre woven. Preferably, a glass fibre nonwoven is used that can preferably have a surface weight of between 30 and 60 g/m² and a thickness of between 0.20 and 0.45 mm, for example between 0.25 and 0.45 mm.

According to embodiments, the amount of ferromagnetic and/or ferrimagnetic particles can be in the range of 15 to 75 vol %. Preferably, this amount is in the range of 17 to 70 vol %. The volume percent indicates the volume of particles relative to the volume of the layer in which the particles are present.

According to embodiments, the ferromagnetic and/or ferrimagnetic particles have an average size of 0.5 to 5 μm. Preferably, this average size is in the range of 1 to 4 μm, such as in the range of 1 to 3 μm.

According to embodiments, the second thermoplastic material can be unfoamed thermoplastic material. According to embodiments, the second thermoplastic material can be foamed thermoplastic material. A foamed layer refers to a layer that comprises hollow spaces, preferably in an amount such that the density of the material is decreased by at least 10%, and preferably even at least 25%, relative to the weight of the same volume of thermoplastic material without hollow spaces. Preferably, this is so-called “closed cell” foam, although the foam can also be open foam. An unfoamed layer refers to a layer without hollow spaces, or at most with a proportion of hollow spaces such that the density of the material does not decrease or does not decrease more than 10%, and preferably even not more than 2%.

In general, it is also noted that in the context of the invention, a foamed layer need not necessarily be foamed in a uniform manner. It is possible for the foamed layer to comprise a varying number of hollow spaces throughout its thickness. For example, the highest proportion can be reached in the centre of the layer, while on one or more of the surfaces of such a layer, less foamed or even unfoamed zones may be present.

The foamed layer can be obtained in different possible ways, with the three primary possibilities being listed below.

According to a first possibility, the foamed layer is obtained at least by means of a mechanical foaming process. This means that holes are formed in the relevant layer by displacing the thermoplastic material and replacing it with a gas (for example air), often under the influence of a mechanical action or by blowing in a gas (for example air) under pressure.

According to a second possibility, the foamed layer is obtained at least by means of a chemical foaming process. This means that holes are formed in the relevant layer by means of a gaseous reaction product. For example, azodicarbonamide can be used. When heated, this substance releases nitrogen gas that remains in the foamed layer in the form of bubbles.

According to a third possibility, the foamed layer is obtained at least by means of fillers, wherein these fillers themselves comprise one or more holes. For example, one can make use of the expanded state of microspheres in this case, or the layer can be obtained by using expanding granules in a PVC-based layer. More specifically, one can use the microspheres known from WO 2013/178561.

The thermoplastic polymer material of the first and/or the second or further layer can also comprise fillers in addition to a polymer matrix.

Fillers can include glass fibres, calcium hydroxide (slaked lime), calcium carbonate and calcium hydrogen carbonate, talc, or also light-weight fillers such as hollow microspheres (Expancel), as well as organic or inorganic dyes or organic or inorganic pigments, for example carbon black pigment. These fillers can be present in an amount of 80 wt %. The above-mentioned percent by weight (wt %) is expressed as the weight of the filler relative to the weight of the thermoplastic material in which the filler is located.

Furthermore, the thermoplastic polymer material can also comprise additives such as flame retardants, antioxidants, antifungals, UV stabilizers, and the like.

According to embodiments, the panel can comprise a decorative layer that is visible on the upper side. According to embodiments, the decorative layer can comprise a printed PVC film. According to some embodiments, the decorative layer comprises a printed motif. According to some embodiments, the decoration comprises a thermoplastic film, preferably PVC film. According to some embodiments, the film is provided with a decorative print. According to some embodiments, the printed motif is an inkjet printed motif. According to some embodiments, the printed motif is an inkjet printed motif that is printed on the upper side of the upper second or one of the multiple layers of thermoplastic material.

According to embodiments, a wear layer can be provided on the decorative layer toward the upper side. According to embodiments, the wear layer can be a transparent or translucent PVC layer that optionally comprises wear-resisting or wear-resistant particles.

Preferably, such a wear layer primarily consists of thermoplastic material, preferably PVC, for example with a thickness of between 0.15 and 0.75 mm.

According to some embodiments, the wear layer comprises a lacquer layer bordering on the surface. According to embodiments, the upper side can be provided by a lacquer layer, optionally provided with indentations or embossing.

Examples of usable lacquer layers are lacquer layers based on urethane acrylates, polyester acrylates and/or epoxide acrylates. The lacquer layer can be a lacquer layer that is cured by means of UV radiation or excimer radiation. The lacquer layer can also comprise wear-resistant particles.

The relevant lacquer layer can comprise hard particles, for example of aluminium oxide, for example corundum, and/or silica in order to obtain increased wear resistance.

According to embodiments, the panel can have a square, parallelogram-shaped, trapezoidal, diamond-shaped or rectangular perimeter.

According to embodiments, the relevant floor panel can be provided on at least two opposite edges with coupling means that allow two of such floor panels to be coupled to each other. According to embodiments, the relevant floor panel can be provided on the at least two other opposite edges with coupling means that allow two of such floor panels to be coupled to each other. The coupling means can be tongue and groove systems that allow a coupling to be formed that prevents mutual relative displacements in the horizontal, vertical, or both directions. Preferably, the coupling means are configured such that the first polymer layer is not part of the tongue and groove. The tongue and groove are preferably configured only in the second and/or further polymer layers.

According to embodiments, the ferromagnetic and/or ferrimagnetic particles can be magnetic.

According to a fourth aspect, a coating of a floor or wall surface is provided, wherein the floor or wall surface is provided with a structure with ferromagnetic or ferrimagnetic properties, and wherein one or more floor or wall panels according to the second or third aspect is/are attached to this structure via a magnetic force.

According to embodiments, with respect to the structure, a coating can be applied to the floor or wall surface such as the coatings described in WO 2013182440 A, WO 2006008445 A or EP 1769527 A1. According to embodiments, with respect to the structure, a metal plate can be applied to the floor or wall surface.

According to embodiments, a flexible polymer structure can be applied to the relevant structure, for example an underfloor that is applied with a first side to the floor or wall surface, and wherein the second side has ferromagnetic or ferrimagnetic properties. The underfloor can be an underfloor such as will be further described according to the fifth aspect of the invention.

According to embodiments, the polymer structure, at least on the second side, can comprise ferromagnetic and/or ferrimagnetic particles.

According to embodiments, the structure can be magnetic, and the one or more floor or wall panels can comprise ferromagnetic and/or ferrimagnetic particles on the underside. According to embodiments, the structure can be ferromagnetic and/or ferrimagnetic, and the one or more floor or wall panels can comprise ferromagnetic and/or ferrimagnetic particles on the underside that are magnetized.

According to a fifth aspect, an underfloor is provided comprising a flexible, layered polymer structure, wherein the structure comprises at least two layers, wherein the layer that provides the upper side comprises ferromagnetic or ferrimagnetic particles. The ferromagnetic or ferrimagnetic particles are identical to those described for the other aspects of the invention.

According to embodiments, the polymer structure can comprise PVC.

According to embodiments, the layer that provides the upper side can be a foamed polymer.

According to embodiments, one or more layers, which are layers that do not provide the upper side of the underfloor, can be foamed.

According to embodiments, the upper side can further be provided with an adhesive layer. According to embodiments, the adhesive can be a reusable adhesive.

An article can thus be held in the place by this reusable adhesive, but the article can also be again removed from the surface using a small force, wherein the adhesive remains on the surface and can later be reused in order to glue an article to this side.

If applicable, reinforcing layers consisting of textile reinforcing layers, for example nonwovens or wovens, for example glass fibre nonwovens, can also be applied between the layers. Such a layered underfloor can be produced by known techniques, such as bringing together sol-gel layers, or by extrusion or co-extrusion.

The ferromagnetic or ferrimagnetic particles are identical or similar to the particles described for the first aspect of the invention. These particles can again consist for example of iron or iron alloys, nickel, cobalt, aluminium and/or copper, optionally with other alloy elements, or can be ceramic substances comprising barium ferrite (BaFe₁₂O₁₉), strontium ferrite (SrFe₁₂O₁₉) or barium strontium ferrite (BaₓSr₁₋ₓFe₁₂O₁₉).

According to embodiments, these ferromagnetic or ferrimagnetic particles can be magnetic.

In a manner identical to that described for the layers of the panels according to the first aspect of the invention, the layers can be mechanically or chemically foamed, or foamed by means of fillers.

Preferably, the layers are made from soft polymers.

Features such as those described for the first, second, third and fourth aspect of the invention are also applicable to the underfloors according to this fifth aspect of the invention.

In a similar manner, and thus according to a sixth independent aspect of the invention, a laminate panel is provided, wherein during production of the wood-fibre-comprising core, ferromagnetic or ferrimagnetic particles are scattered along with the wood particles that are successively embedded in the core during curing thereof into an MDF or HDF core. If applicable, the wood-fibre-comprising core is produced from at least two layers, wherein the ferromagnetic or ferrimagnetic particles are placed only in the layer that is to provide the lower layer of the MDF or HDF core.

Therefore, according to a sixth aspect, a method is provided for producing a floor or wall panel, comprising
the provision of a wood-fibre-based core, comprising at least a first side of the core;
the provision of a decorative layer on the side of the core opposite to the at least one side of the core;
the optional provision of a translucent or transparent wear layer in contact with the decorative layer;
the optional provision of a balancing layer on the at least one side of the core;
   wherein ferromagnetic and/or ferrimagnetic particles are provided on the at least one side of the core and/or if applicable in the balancing layer.

According to embodiments, the ferromagnetic and/or ferrimagnetic particles can be provided on the at least one side of the core by the scattering of ferromagnetic and/or ferrimagnetic particles during production of the core.

According to embodiments, the wood-fibre-based core can be produced from glued wood fibres, and the ferromagnetic and/or ferrimagnetic particles are comprised in the adhesive.

According to embodiments, the core can comprise at least two wood fibre layers, wherein the first layer provides the at least one side of the core and wherein the ferromagnetic and/or ferrimagnetic particles are scattered before or during the scattering of the wood fibres of this first layer.

According to embodiments, the second and optionally further wood fibre layers are free of ferromagnetic and/or ferrimagnetic particles.

According to embodiments, ferromagnetic and/or ferrimagnetic particles can be provided in the balancing layer.

According to embodiments, the balancing layer can comprise a resin-impregnated paper, wherein the ferromagnetic and/or ferrimagnetic particles are contained in the paper.

According to embodiments, the balancing layer can comprise a resin-impregnated paper, wherein the ferromagnetic and/or ferrimagnetic particles are contained in the resin.

According to embodiments, the ferromagnetic and/or ferrimagnetic particles can be provided on the balancing layer, preferably by scattering, before the provision of a balancing layer on the at least one side of the core.

As in the other aspects of the invention, the methods can of course comprise the step of permanently magnetizing the ferromagnetic and/or ferrimagnetic particles, for example by exposing the panels to a relatively strong magnetic field.

According to a seventh aspect, a floor or wall panel is then also provided, the panel comprising a wood-fibre-based core comprising at least a first side of the core; a decorative layer on the side of the core, opposite to the at least one side of the core; optionally a translucent or transparent wear layer in contact with the decorative layer and a balancing layer on the at least one side of the core, wherein ferromagnetic and/or ferrimagnetic particles are provided in the core on the at least one side and/or in the balancing layer.

The core can be an MDF or HDF core. At the level of the layer in which the ferromagnetic and/or ferrimagnetic particles are present, the concentration of the ferromagnetic and/or ferrimagnetic particles is between 15 and 75 vol %, for example 50 vol %.

Features such as described for the first, second, third, fourth and fifth aspect of the invention are also applicable for the methods according to the sixth aspect and the panels according to the seventh aspect of the invention.

The independent and dependent claims represent specific and preferred features of the embodiments of the invention. Features of the dependent claims can be combined with features of the independent and dependent claims, or with features described above and/or below, and this in any suitable manner that would be clear to the person skilled in the art.

The above-mentioned and other features, properties and advantages of the present invention will be clarified by means of the following exemplary embodiments, optionally in combination with the drawings.

The description of these exemplary embodiments is given as a clarification, without the intention of limiting the scope of the invention. The reference numbers in the following description refer to the drawings. The same reference numbers in possibly different figures refer to identical or similar elements.

### BRIEF DESCRIPTION OF THE FIGURES

In the following, in order to better explain the features of the invention, several preferred embodiments are described with reference to the attached drawings as examples that are by no means limitative, wherein:

FIG. 1 is a schematic representation of a floor panel according to the invention on an underfloor also according to the invention.

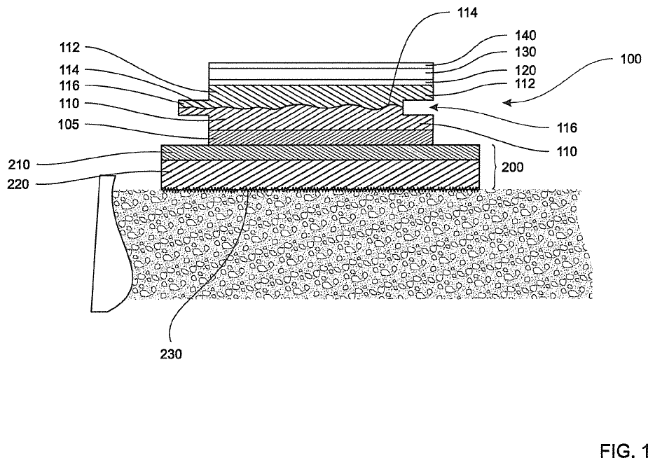

### DESCRIPTION OF EXEMPLARY EMBODIMENTS

The present invention is described below by means of specific embodiments.

It must be noted that the term “comprising”, as used for example in the claims, may not be interpreted in a limitative sense, limited to the following elements, features and/or steps. The term “comprising” does not exclude the presence of other elements, features or steps.

Therefore, the scope of the expression “an article comprising the elements A and B” is not limited to an article that only comprises the elements A and B. The scope of the expression “a method comprising the steps A and B” is not limited to a method that only comprises the steps A and B.

In the context of the present invention, these expressions mean only that the relevant elements or steps of the invention are the elements or steps A and B.

In the following specification, reference is made to “an embodiment” or “the embodiment”. Such a reference means that a specific element or feature described by means of this embodiment is contained in at least this one embodiment.

However, the occurrence of the terms “in an embodiment” or “in the embodiment” at different locations in this description does not necessarily refer to the same embodiment, although it can indeed refer to the same embodiment.

Furthermore, the properties or the features can be combined in any suitable manner in one or multiple embodiments, such as would be clear to the person skilled in the art.

A first embodiment of a floor panel 100 is produced by means of a dual belt press. This press comprises two Teflon-coated polymer conveyor belts that rotate together above one another and in opposite directions. They form a product gap over a significantly long distance in which a plate-shaped product can be produced. The press has a heating zone, a pressing zone and thereafter a cooling zone. The product gap extends out through the heating, pressing and cooling zone. For the heating zone, the lower of the two conveyor belts extends farther out than the upper one. This creates a surface where particulates or particles can be scattered on the lower conveyor belt.

A mixture of the thermoplastic PVC particles and ferromagnetic strontium ferrite particles is provided. A first layer of thermoplastic particles, being PVC particles, together with ferromagnetic and/or ferrimagnetic particles that are strontium ferrite particles, is scattered in order thus to form a thin layer in which the PVC and strontium ferrite particles are homogeneously distributed in the thickness and over the surface.

The PVC particles are characterized by an average diameter of 100 to 750 μm, for example 300 μm. The PVC particles are sieved such that no particles with a diameter greater than 1000 μm are present.

The strontium ferrite particles are characterized by an average diameter of 0.5 to 5 μm.

The amount of strontium ferrite particles in the mixture, and thus in the scattered layer, is between 15 and 75 vol %, for example 50 vol %.

A second layer of PVC particles is scattered on this first thin layer. A glass fibre nonwoven approximately 0.05 mm in thickness is then laid on these two thin layers, after which a further thin layer of PVC particles is scattered on the glass fibre nonwoven. The PVC particles of the second and third layer are characterized by having an average diameter of 100 to 750 μm.

The PVC used in these layers is typically a K64, K60, K57 or K50 PVC with . . .

The PVCs used preferably have a K value (Fikentscher) of less than or equal to 85, for example less than or equal to 60, for example less than 58, such as for example a K value of 57 or 50. Such PVC can also be a copolymer of vinyl chloride (VC) and vinyl acetate (VA), for example copolymers with a VC/VA ratio of 70/30 to 50/50.

For each 100 parts by weight of PVC, the composition comprises 36 to 50 parts by weight of plasticizers such as DOPT, DINCH and/or DINP, 210 parts by weight of a filler, typically calcium carbonate, and further several parts by weight of additives such as stabilizers, for example thermal stabilizers, and processing aids, dyes and/or carbon black, etc.

If applicable, a foam-forming additive can be added.

The stacked thin layers are moved into the product gap and, by means of the movement of the conveyor belts, guided between the heating elements of the heating zone. The PVC particles melt into a PVC matrix, while in the lower part, the strontium ferrite particles are embedded in this PVC matrix.

In the pressing zone, the layers are compacted by means of an S-bend. After this, the compacted layers are cooled by the plates of the cooling zone. The amounts of the PVC and strontium ferrite particles are selected such that after the cooling zone, e.g. a PVC intermediate product is obtained with a total thickness of approximately 1.65 mm, wherein the glass fibre nonwoven separates two zones, on the one side a PVC zone with particles loaded on the outside only with strontium ferrite measuring a good 1.45 mm in thickness, and on the other side a PVC zone a good 0.15 mm in thickness. In alternative embodiments, the amount of PVC is selected such that a PVC intermediate product is obtained with a total thickness of approximately 1.9 mm, wherein the glass fibre nonwoven separates two zones, on the one side a PVC zone with particles loaded on the outside only with strontium ferrite measuring a good 1.55 mm in thickness, and on the other side a PVC zone a good 0.3 mm in thickness. In still another alternative embodiment, the amount of PVC is selected such that a PVC intermediate product is obtained, wherein the glass fibre nonwoven separates two zones, on the one side a PVC zone with particles loaded on the outside only with strontium ferrite measuring a good 2.55 mm in thickness and on the other side a PVC zone with a thickness that can be selected between 1.25 mm and 1.55 mm.

After leaving the cooling zone, a PVC printed decorative layer 120 and a PVC transparent wear layer 130 are laminated onto the upper third layer by thermal lamination. A typical thickness of the PVC printed decorative layer 120 is approximately 0.1 mm, and that of a wear layer 130 is selected between 0.2 and 0.55 mm.

After this, the wear layer is imprinted or pressed (embossed), and a UV curing PU resin layer 140 is then applied. Finally, the endless long slab is cut into panels and provided with coupling means in a known manner.

In a following step, the strontium ferrite particles are magnetically oriented, causing them to have a magnetic action, i.e. each of them is active as a magnet, wherein the magnetic fields of adjacent particles are aligned with each other so that the surface as a whole also has a magnetic action.

In cross section, the panels thus obtained have a layered structure. The lower layer 105, away from the outer side formed by the resin of the PU resin layer 140, is a PVC layer having on its underside a zone loaded with strontium ferrite.

A panel is thus obtained with a PVC core into which the coupling means 116 are optionally incorporated, for example by milling.

In a similar manner, panels can be produced with the same instruments. Instead of a mixture of thermoplastic PVC particles and ferromagnetic strontium ferrite particles, a thin layer of ferromagnetic strontium ferrite particles is first scattered. The strontium ferrite particles are characterized by an average diameter of 0.5 to 5 μm.

A first layer of thermoplastic particles, being PVC particles, is scattered onto this layer of strontium ferrite particles.

The PVC particles are characterized by an average diameter of 100 to 750 μm, for example 300 μm. The PVC particles are sieved such that no particles with a diameter of greater than 1000 μm are present.

In an alternative embodiment, the PVC particles are replaced by PVC granules, which for example are essentially cylindrical in shape, with a diameter of between 2.8 and 3.2 mm and a height of approximately 0.5 mm.

The amount of strontium ferrite particles in the mixture, and thus in the scattered layer, is between 15 and 75 vol %, for example 50 vol %.

After this, a glass fibre nonwoven approximately 0.05 mm in thickness is laid on these two thin layers, after which a further thin layer of PVC particles is scattered on the glass fibre nonwoven. This third layer can again consist of PVC particles that are characterized by an average diameter of 100 to 750 μm, for example 300 μm. The PVC particles are sieved such that no particles with a diameter greater than 1000 μm are present. As another alternative, the PVC particles are replaced by PVC granules, which for example are essentially cylindrical in shape, with a diameter of between 2.8 and 3.2 mm and a height of approximately 0.5 mm.

The PVC used is identical to the composition mentioned above.

The stacked thin layers are moved into the product gap of the press, and a panel is then obtained by the same steps as described above.

In a further alternative embodiment, the strontium ferrite particles are embedded in a PVC melt, which is extruded into granules of cylindrical shape with a typical size of 1.2 to 3.2 mm in diameter and a length of around 0.5 to 1 mm. These PVC-comprising granules are scattered, said granules thus being a combination of the PVC compound and the strontium ferrite particles. Again, granules are preferably used that for example have an essentially cylindrical shape, with a diameter of between 2.8 and 3.2 mm and a height of approximately 0.5 mm. A glass fibre nonwoven approximately 0.05 mm in thickness is laid on the first layer of granules loaded with strontium ferrite, after which a further thin layer of PVC particles is scattered on the glass fibre nonwoven. This layer can again consist of PVC granules, for example having an essentially cylindrical shape, with a diameter of between 2.8 and 3.2 mm and a height of approximately 0.5 mm. These granules comprise no strontium ferrite particles.

The PVC used is identical to the composition mentioned above.

The stacked thin layers are moved into the product gap of the press, and a panel is then obtained by the same steps as described above.

On one side (the underside), all of these panels thus have a zone loaded with strontium ferrite, where these particles are embedded in the polymer matrix that also provides the core of the panel. The strontium ferrite particles are fused into this polymer matrix, which makes the particles difficult to separate from the surface of the panel.

These obtained panels, which are magnetic on the underside, can be attached via magnetism to a floor or wall surface that has metallic surface properties. For example, this surface can be provided by a coating, for example a layer of paint, that comprises metallic particles.

If applicable, an underfloor 200 can be provided according to the invention that comprises strontium ferrite particles or other ferro- or ferrimagnetic particles in the layer 210 that provides its upper surface. Such an underfloor can be an underfloor that consists for example of three layers, a first layer being a textile carrier 230, for example of a nonwoven polyester textile material, onto which a soft and foamed PU layer 220 is extruded, and on which in turn is provided by extrusion a foamed, soft PU layer 210 that comprises 15 to 75 vol %, for example 50 vol % of strontium ferrite or other ferro- or ferrimagnetic particles with an average diameter of 0.5 to 5 μm.

The underfloor can optionally be provided with ferro- or ferrimagnetic particles and properties by providing an underfloor such as described in EP 2671853 B1.

It is clear that although the embodiments and/or materials for providing the embodiments according to the present invention are discussed, various modifications or changes can be made without departing from the scope of action and/or the spirit of this invention. The present invention is by no means limited to the embodiments described above, but can be implemented according to different variants without departing from the scope of the present invention.

1.-65. (canceled)

66. A method for producing a floor or wall panel, comprising:
the provision of a first thermoplastic polymer layer that comprises a polymer matrix and ferromagnetic and/or ferrimagnetic particles;
the provision of a second thermoplastic polymer layer, wherein the second layer is in contact with the first layer along a side of the first layer;
the optional provision of one or more further thermoplastic polymer layers on the side of the second layer opposite to the side in contact with the first layer;
the bonding to one another of the first, the second and the optionally further polymer layers under elevated temperature and pressure;
the provision of a decorative layer on the side of the second layer opposite to the side in contact with the first layer or if applicable on the side of one of the further polymer layers, which side is oriented away from the first polymer layer;
the optional provision of a translucent or transparent wear layer in contact with the decorative layer.

67. The method in accordance with claim 66, wherein the first and/or second polymer layer is provided by extrusion, possibly co-extrusion.

68. The method in accordance with claim 66, wherein the polymer materials of the first and second polymer layer comprise polyvinyl chloride (PVC).

69. The method in accordance with claim 66, wherein the second thermoplastic material is unfoamed thermoplastic material.

70. The method in accordance with claim 66, wherein the method also comprises a step wherein the above-mentioned ferromagnetic and/or ferrimagnetic particles are magnetized.

71. The method in accordance with claim 66, wherein the method further comprises the cutting of the layered structure obtained into panels, and wherein the panels are provided on one or more sides with a coupling system.

72. A floor or wall panel, wherein the panel comprises an upper side and an underside, the panel comprising a core of thermoplastic polymer material that provides the floor panel with its underside, wherein the thermoplastic polymer material comprises a polymer matrix and ferromagnetic and/or ferrimagnetic particles.

73. The floor or wall panel in accordance with claim 72, wherein the core of thermoplastic polymer material consists of different layers,
wherein the panel comprises an upper side and an underside, the panel comprising a first layer of a first thermoplastic polymer material and at least a second layer of a second thermoplastic polymer material,
wherein this first layer provides the floor panel with its underside, the second layer is in contact with the first layer along the side of the first layer different from the underside,
wherein the first layer of a first thermoplastic polymer material comprises a polymer matrix and ferromagnetic and/or ferrimagnetic particles,
wherein the thermoplastic polymer material of the second layer and the polymer matrix of the first layer are fused to one another,
wherein the first thermoplastic polymer material is polyvinylchloride.

74. The floor or wall panel in accordance with claim 73, wherein the second thermoplastic polymer material is polyvinylchloride.

75. The floor or wall panel in accordance with claim 72, wherein the particles are permanent magnetic particles, ferrite particles or strontium ferrite particles.

76. The floor or wall panel in accordance with claim 72, wherein the second thermoplastic material is unfoamed thermoplastic material.

77. The floor or wall panel in accordance with claim 72, wherein the floor panel is provided on at least two opposite edges with coupling means that allow two of such floor panels to be coupled to each other.

78. Coating of a floor or wall surface, wherein the floor or wall surface is provided with a structure with ferromagnetic or ferrimagnetic properties, and
wherein one or more floor or wall panels in accordance with claim 72 are attached to this structure via a magnetic force, and
wherein the structure is a coating applied to the floor or wall surface, a metal plate applied to the floor or wall surface, or a flexible polymer structure.

79. An underfloor comprising a flexible, layered polymer structure, wherein the structure comprises at least two layers, wherein the layer that provides the upper side comprises ferromagnetic or ferrimagnetic particles.

80. The underfloor in accordance with claim 79, wherein the upper side is further provided with an adhesive layer.
